(19) United States
(12) Patent Application Publication
(10) Pub. No.: US 2019/0285179 A1
(43) Pub. Date: Sep. 19, 2019

(54) METAL GASKET, AND METHOD FOR MANUFACTURING GASKET-CONSTITUTING PLATE USED FOR THE METAL GASKET

(71) Applicant: Kokusan Parts Industry Co., Ltd., Toyonaka-shi (JP)

(72) Inventor: Yoshitaka ABE, Osaka (JP)

(73) Assignee: Kokusan Parts Industry Co., Ltd., Toyonaka-shi (JP)

(21) Appl. No.: 16/358,402

(22) Filed: Mar. 19, 2019

(30) Foreign Application Priority Data
Mar. 19, 2018 (JP) 2018-051188

(51) Int. Cl. F16J 15/08; F16J 15/10

(52) U.S. Cl. CPC F16J 15/0818; F16J 2015/0856; F16J 15/104; F16J 15/102

(57) ABSTRACT

A metal gasket is capable of increasing bonding strength of a seal member through pressure bonding, enhancing sealing performance as a whole, and reducing the manufacturing cost. A method for manufacturing a gasket-constituting plate is capable of reducing the manufacturing cost of the gasket-constituting plate, and increasing bonding strength of a seal member to a blank metal plate through pressure bonding. Two gasket-constituting plates are layered on each other. Covering parts each having a width are provided on an outer surface of the first gasket-constituting plate, along beads so as to cover the beads in a plan view. Seal projecting parts are provided on outer surfaces of the covering parts along the covering parts so as to project outward in the thickness direction. Seal members including the covering parts and the seal projecting parts, respectively, are composed of a single member integrally molded by using a rubber material.

### BACKGROUND OF THE INVENTION

### Field of the Invention

The present invention relates to a metal gasket which can be suitably used as a head gasket for a vehicle engine, and a method for manufacturing a gasket-constituting plate used for the metal gasket.

### Description of the Background Art

Recent engines emphasizing fuel economy have been developed along with lightweight technology while enhancing combustion efficiency. In particular, if weight reduction is not optimally designed, engine rigidity is not maintained, which may cause an increase in deviation from flatness when mating faces of a cylinder head and a cylinder block are fastened. Thus, a head gasket is required to have high sealing performance. However, since a camshaft and a crankshaft are rotary shafts, these shafts need to have enough rigidity to inhibit certain deflection, even when the engine rigidity is reduced. In particular, since a cylinder head, in which the camshaft is disposed, is influenced by bolt fastening, reduction in axial force of fastening bolts is an effective means. However, reduction in axial force of fastening bolts may be a major cause of reduction in sealing performance of the head gasket.

From the above facts, in order to maximally enhance sealing performance of a head gasket, a metal plate having a rubber layer formed over one surface or both surfaces thereof has been proposed and put to practical use as a blank metal plate for a gasket-constituting plate of the head gasket (refer to Patent Literature 1, for example).

However, such a rubber layer may be formed on a contact portion with engine cooling water. In such a case, if a portion of the rubber layer is peeled off, the peeled rubber piece is mixed in the cooling water and causes clogging, which may deteriorate cooling performance.

Therefore, for example, a portion of the rubber layer, facing a water jacket, of the gasket-constituting plate as described in Patent Literature 1, may be removed with a water jet, or a liquid rubber material may be applied by spray coating or screen printing only to a bead and a desired part facing the bead to form a coating layer made of the rubber material, thereby providing a metal gasket which maximally prevents deterioration in cooling performance due to peeling off of the rubber layer (refer to Patent Literature 2, for example).

Meanwhile, a head gasket has been proposed which includes, as coating layers formed on a gasket-constituting plate, a microseal coating using NBR (nitrile rubber), fluororesin, or the like applied over the entire surface of a metal plate, and a seal coating formed so as to surround holes such as cylinder bore holes, liquid holes for circulation of cooling water and engine oil, bolt holes for fastening bolts, gear box holes, etc. In this gasket, the thickness of the seal coating is made larger than that of the micro seal coating to form a plurality of seal lines by the seal coating, thereby enhancing sealing performance (refer to Patent Literature 3, for example).

### CITATION LIST

### Patent Literature

[Patent Literature 1] Japanese Unexamined Patent Application Publication No. 2008-164122

[Patent Literature 2] Japanese Unexamined Patent Application Publication No. 2000-28002.

[Patent Literature 3] Japanese Patent No. 3547417

### SUMMARY OF THE INVENTION

However, in the case where an unnecessary portion of a rubber layer is removed with a water jet, the work for removing the unnecessary portion takes a lot of time, which may cause a reduction in productivity of the head gasket. In addition, wasteful use of the rubber material may cause an increase in manufacturing cost of the head gasket. Furthermore, only a rubber layer having a uniform thickness can be formed, and coating layers of different heights as described in Patent Literature 3 cannot be formed.

Meanwhile, in the case where a coating layer is formed by screen printing, in contrast to the case of forming a rubber layer over one surface or both surfaces of a metal plate, the work for removing an unnecessary portion is not needed, and thus productivity can be enhanced. Further, the manufacturing cost of the head gasket can be reduced by maximally inhibiting wasteful use of the rubber material. In addition, coating layers having different heights and/or materials as described in Patent Literature 3 can be formed.

However, a liquid rubber material obtained through dilution with an additive solvent needs to be used as a rubber material for screen printing. Moreover, since the applied rubber material is not pressure-bonded to the metal plate, bonding strength of the coating layer to the metal plate is reduced.

In the case where coating layers having different heights are formed as in Patent Literature 3, it is necessary to perform spray coating with the gasket-constituting plate being masked for each of the coating layers having different heights, or to perform screen printing using different screens for the respective coating layers, and thus the number of steps for forming the coating layers increases, which may cause a reduction in productivity and an increase in manufacturing cost. Moreover, in the case where a narrow coating layer such as a seal coating as described in Patent Literature 3 is formed, the contact area between the coating layer and a metal plate is reduced, and therefore, the coating layer inevitably tends to easily peel off.

An object of the present invention is to provide: a metal gasket capable of increasing bonding strength of a seal member through pressure bonding, enhancing sealing performance as a whole, and reducing the manufacturing cost; and a method for manufacturing a gasket-constituting plate, which is capable of reducing the manufacturing cost of the gasket-constituting plate, and of increasing bonding strength of a seal member to a blank metal plate through pressure bonding.

The present invention has the following features to attain the object mentioned above.

(1) A metal gasket includes: a single gasket-constituting plate on which a bead for sealing is provided; a covering part having a width, the covering part being provided on at least one surface of the gasket-constituting plate, along the bead so as to cover the bead; a seal projecting part provided on an outer surface of the covering part, along the covering part, the seal projecting part projecting outward in a thickness direction of the covering part; and a seal member including the covering part and the seal projecting part, the seal member being composed of a single member that is integrally molded on the gasket-constituting plate by using a rubber material.

(2) A metal gasket includes: a plurality of gasket-constituting plates layered on each other, at least one of the gasket-constituting plates being provided with a bead for sealing; a covering part having a width, the covering part being provided on an outer surface of one of the gasket-constituting plates, which is disposed on at least one of outer sides among the plurality of gasket-constituting plates, along the bead so as to cover the bead in a plan view; a seal projecting part provided on an outer surface of the covering part, along the covering part, the seal projecting part projecting outward in a thickness direction of the covering part; and a seal member including the covering part and the seal projecting part, the seal member being composed of a single member that is integrally molded by using a rubber material. The wording “the covering part being provided so as to cover the bead in a plan view” means both a case where the covering part is disposed on the upper surface of the bead or on one surface of the gasket-constituting plate on the upper side relative to the upper surface of the bead so as to cover the upper surface side of the bead, and a case where the covering part is disposed on the lower surface of the bead or on one surface of the gasket-constituting plate on the lower side relative to the lower surface of the bead so as to cover the lower surface side of the bead.

When the metal gasket according to the above (1) or (2) is interposed between two members such as a cylinder head and a cylinder block, fluids such as combustion gas, cooling water, and lubricating oil are sealed between the two members. In particular, the cylinder head and the cylinder block are formed of casting, and have a surface rougher than that of the metal gasket. Therefore, sealing performance at the contact portion of the metal gasket with the cylinder head or the cylinder block easily deteriorates. Thus, when the seal member made of the rubber material is formed on at least one outer surface so as to cover the bead as in the metal gasket of the above (1) or (2), sealing performance can be enhanced. In addition, when the seal member is provided with the seal projecting part as in the metal gasket of the above (1) or (2), not only the bead but also the seal projecting part can contribute to enhancement of sealing performance. Furthermore, in the metal gasket of the above (1) or (2), since the seal member is composed of a single member integrally molded by using a rubber material, the following functions and effects can be achieved, in contrast to the case where a seal member is formed through spray coating or screen printing. That is, bonding strength of the seal member to the metal substrate of the gasket-constituting plate can be enhanced through pressure bonding. Even when a narrow seal projecting part is formed, peeling of the seal projecting part can be effectively avoided. The seal member having the seal projecting part can be molded without increasing the number of process steps, and wasteful use of the rubber material can be minimized by forming the seal member only on a desired portion, whereby the manufacturing cost of the metal gasket can be reduced.

(3) In the metal gasket according to the above (2), the gasket-constituting plate having the bead may be disposed on the at least one of the outer sides among the plurality of gasket-constituting plates, and the covering part is provided on the outer surface of the gasket-constituting plate having the bead, along the bead so as to cover the bead.

(4) In the metal gasket according to any one of the above (1) to (3), the seal projecting part may be provided outward with respect to a seal line of the bead. For example, in a combustion chamber bead that seals the periphery of a combustion chamber of a vehicle engine, sealing is performed so as to isolate combustion gas inside the combustion chamber bead from cooling water outside the combustion chamber bead, and thus the combustion gas is substantially sealed by the bead. In addition, the gap between the covering part and the cylinder block or the cylinder head is extremely small. Accordingly, even if the combustion gas leaks to some extent from the bead toward the cooling water, the gas pressure of the leaked combustion gas becomes very low due to pressure loss. In the present invention, a seal projecting part is provided outward with respect to the seal line of the bead. Thus, even if the combustion gas is likely to leak to some extent from the bead toward the cooling water, the combustion gas can be reliably sealed by the seal projecting part. Furthermore, the cooling water and the lubricating oil are lower in pressure than the combustion gas, and therefore are sealed by the bead and the seal projecting part so that the fastening force of head bolts acts on the combustion chamber bead.

(5) In the metal gasket according to any one of the above (1) to (4), fluororubber may be used as a rubber material forming the seal member.

(6) A method for manufacturing a gasket-constituting plate includes: placing uncured material rubber pieces on a blank metal plate so as to correspond to a position where a bead is disposed; and heating and compressing the material rubber pieces between the blank metal plate and a compressing face of a mold, along a position where the bead is disposed, to cure and spread the material rubber pieces, so that a seal member having a covering part is molded with the material rubber pieces on the blank metal plate so as to correspond to the position where the bead is disposed.

In this manufacturing method, the uncured material rubber pieces are heated and compressed to be cured and spread between the blank metal plate and the mold, so that the seal member is formed along the position where the bead is disposed. Therefore, the manufacturing cost of the gasket-constituting plate can be reduced by minimizing wasteful use of the rubber material. In addition, bonding strength of the seal member to the blank metal plate can be increased through pressure bonding as compared with the case where a seal member is formed through screen printing or spray coating of a liquid rubber material to the blank metal plate.

(7) In the method according to the above (6), the mold may include: a female mold in which a fitting groove is formed so as to correspond to the position where the bead is disposed; and a male mold to be retractably fitted into the fitting groove, and the male mold having, at an end surface thereof, the compressing face for pressurizing the material rubber pieces. In this case, when the bead is molded, burrs of the rubber material, which projects from both sides of the bead can be minimized.

(8) In the method according to the above (6) or (7), a groove extending along the covering part may be provided at the compressing face of the mold, for compressing the material rubber pieces, and when the seal member is molded, the groove may cause a seal projecting part to be molded on an outer surface of the covering part along the covering part, the seal projecting part projecting outward in a thickness direction of the covering part, so that the seal member having the covering part and the seal projecting part is integrally molded on the blank metal plate. In this case, the covering part and the seal projecting part can be simultaneously molded. For example, it is not necessary to form the covering part and the seal projecting part through screen printing using different screens. Thus, simultaneous molding of the covering part and the seal projecting part can be performed without increasing the number of process steps. Moreover, the seal projecting part and the covering part are integrally molded to be a single member. Thus, peeling of the seal projecting part during use of the gasket can be effectively avoided even when the seal projecting part has a narrow width.

(9) The method according to any one of the above (6) to (8) may further include molding a bead along the seal member, on the blank metal plate on which the seal member is molded.

According to the metal gasket of the present invention, bonding strength of the seal member can be increased through pressure bonding, sealing performance of the metal gasket can be enhanced, and moreover; the manufacturing cost of the metal gasket can be reduced.

According to the gasket-constituting plate manufacturing method of the present invention, the manufacturing cost of the gasket-constituting plate can be reduced, and bonding strength of the seal member to the blank metal plate can be increased through pressure bonding.

### BRIEF DESCRIPTION OF THE DRAWINGS

FIG. 1 is a cross-sectional view (taken along a I-I line in FIG. 2) showing a major part, in an exploded state, of an engine to which a metal gasket is incorporated;

FIG. 2 is a plan view of a first gasket-constituting plate;

FIG. 3 is a plan view of the first gasket-constituting plate in a state where seal members are omitted;

FIG. 4A is a plan view of a second gasket-constituting plate;

FIG. 4B is a bottom view of the second gasket-constituting plate;

FIG. 5A is a longitudinal cross-sectional view of a part, near an outer peripheral seal member, of a metal gasket having a first alternative structure;

FIG. 5B is a longitudinal cross-sectional view of a part, near a combustion chamber seal member, of a metal gasket having a second alternative structure;

FIG. 5C is a longitudinal cross-sectional view of a part, near a combustion chamber seal member, of a metal gasket having a third alternative structure;

FIG. 6A is a longitudinal cross-sectional view of a metal gasket having a fourth alternative structure;

FIG. 6B is a plan view of a shim plate used in the metal gasket having the fourth alternative structure;

FIG. 7A is a longitudinal cross-sectional view of a metal gasket having a fifth alternative structure;

FIG. 7B is a longitudinal cross-sectional view of a metal gasket having a sixth alternative structure;

FIG. 7C is a longitudinal cross-sectional view of a metal gasket having a seventh alternative structure;

FIG. 7D is a longitudinal cross-sectional view of a metal gasket having an eighth alternative structure;

FIG. 7E is a longitudinal cross-sectional view of a metal gasket having a ninth alternative structure;

FIG. 8A is a longitudinal cross-sectional view of a metal gasket having a tenth alternative structure;

FIG. 8B is a longitudinal cross-sectional view of a metal gasket having an eleventh alternative structure;

FIG. 8C is a longitudinal cross-sectional view of a metal gasket having a twelfth alternative structure;

FIG. 8D is a longitudinal cross-sectional view of a metal gasket having a thirteenth alternative structure;

FIG. 9 is an exploded perspective view of a mold assembly for molding a seal member;

FIG. 10 is a diagram for explaining a method for molding a seal member, when material rubber pieces are placed;

FIG. 11A is a diagram for explaining the method for molding a seal member, when the material rubber pieces are placed;

FIG. 11B is a diagram for explaining the method for molding a seal member, when the material rubber pieces are heated and compressed;

FIG. 12 is a longitudinal cross-sectional view of a major part of a die for molding a bead, during molding of the bead; and

FIG. 13 is a longitudinal cross-sectional view of a major part of a mold assembly capable of molding seal members on both surfaces of a blank metal plate.

### DESCRIPTION OF THE PREFERRED EMBODIMENTS

Hereinafter, an embodiment of the present invention will be described with reference to the drawings.

In this embodiment, a metal gasket of the present invention is applied to a head gasket for a vehicle engine. In the drawings used for the embodiment, the dimensions of the components of the metal gasket are set to be different from their actual dimensions to emphasize the structure of a major part of the metal gasket.

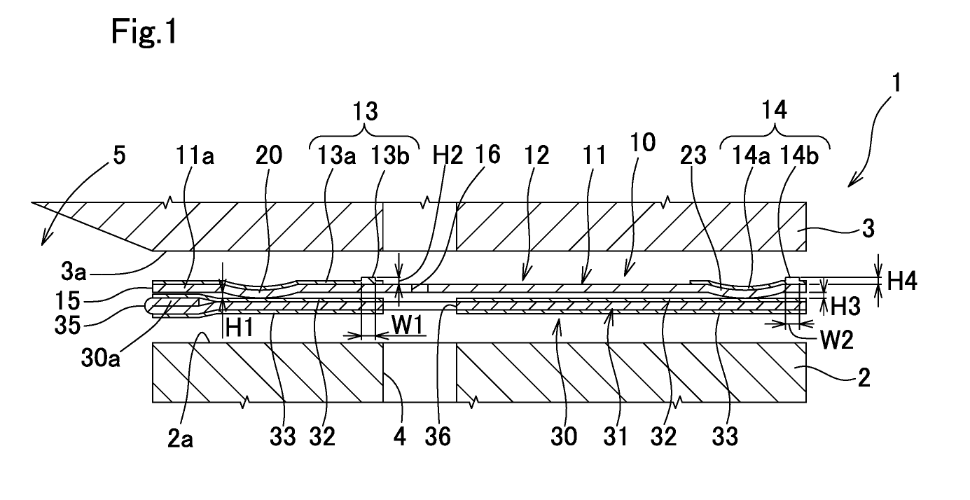

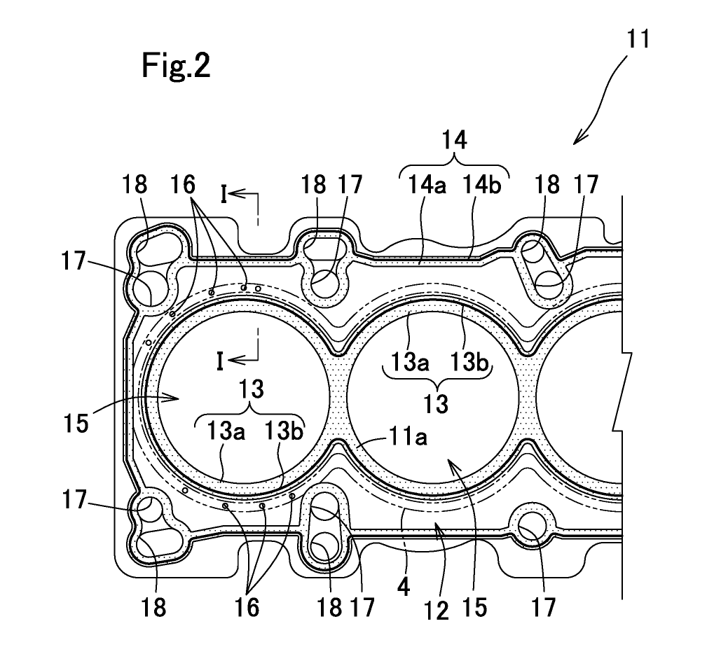

The metal gasket 10 shown in FIGS. 1 and 2 is a metal gasket for a multi-cylinder inline engine. The metal gasket 10 is interposed between mating surfaces 2a and 3a of a cylinder block 2 and a cylinder head 3, respectively, of an engine 1, and seals fluids such as combustion gas, cooling water, and lubricating oil. The engine 1 includes engines having known structures, such as an engine having a cylinder block formed of cast iron, and an engine having a cylinder block and a cylinder head which are formed mainly of a light alloy such as aluminum alloy or magnesium alloy. The metal gasket 10 of the present invention is applicable to such an engine 1. In the present embodiment, the present invention is applied to the engine 1 which includes an open deck type cylinder block 2 having a water jacket 4 whose upper surface is open, and in which the cylinder block 2 and the cylinder head 3 are formed of aluminum alloy. However, the present invention is also applicable to a cylinder block having a water jacket 4 whose upper surface is not open.

The metal gasket 10 includes a first gasket-constituting plate 11 and a second gasket-constituting plate 30, and the gasket-constituting plates 11 and 30 are joined in a layered state.

As shown in FIGS. 1 to 3, the first gasket-constituting plate 11 includes: a first metal substrate 12 formed of a metal material; and a combustion chamber seal member 13 and an outer peripheral seal member 14 which are formed of a rubber material and are layered on the upper surface of the first metal substrate 12. The seal members 13 and 14 are not disposed in the water jacket 4 so as to be prevented from being peeled off due to contact with cooling water, while enhancing sealing performance. The first metal substrate 12 is exposed to the outside in portions thereof other than the portions where the seal members 13 and 14 are disposed. In FIG. 2, in order to clarify the regions of the seal members 13 and 14, the portions where the seal members 13 and 14 are formed are virtually indicated by dots.

The first metal substrate 12 is formed in substantially the same plane shape as the mating surfaces 2a and 3a of the cylinder block 2 and the cylinder head 3, and is formed of a stainless steel plate such as SUS 301 based on JIS, or a known metal material having properties similar to SUS 301. As for the first metal substrate 12, a metal substrate having a thickness of 0.15 mm to 0.4 mm, or 0.1.5 mm to 0.35 mm, for example, may be adopted.

In substantially a center portion, in the width direction, of the first gasket-constituting plate 11, a plurality of combustion chamber holes 15, which are round holes, are formed spaced apart from each other in the longitudinal direction so as to correspond to combustion chambers 5. A plurality of cooling water holes 16 are formed in a prescribed arrangement at positions corresponding to the water jacket 4. A plurality of bolt insertion holes 17 are formed at substantially equal intervals so as to surround the combustion chamber holes 15, at positions outside the water jacket 4. Head bolts (not shown) are inserted in the bolt insertion holes 17 to fix the cylinder head 3 to the cylinder block 2. Oil holes 18, through which lubricating oil passes, are formed outside specific bolt insertion holes 17, so that the lubricating oil is supplied from the cylinder block 2 toward the cylinder head 3 to lubricate a valve mechanism, etc.

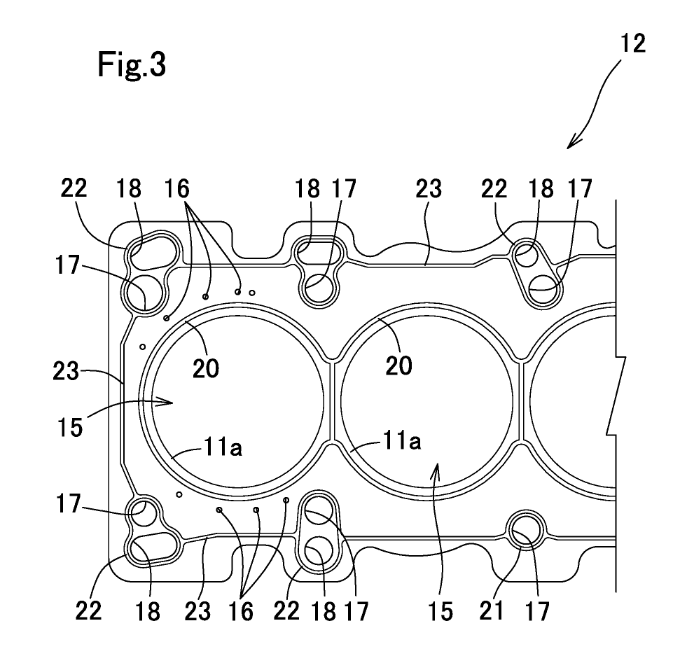

As shown in FIGS. 1 and 3, the first gasket-constituting plate 11 has, formed therein, combustion chamber beads 20 surrounding the combustion chambers 5, bolt hole beads 21 surrounding the bolt insertion holes 17, bolt/oil hole beads 22 surrounding corresponding pairs of the bolt insertion hole 17 and the oil hole 18, and an outer peripheral bead 23, The outer peripheral bead 23 connects the beads 21 and 22 disposed adjacent to each other so as to surround the water jacket 4, and surrounds the water jacket 4 in cooperation with the beads 21 and 22. The outer peripheral bead 23 may be formed in an annular shape that surrounds the water jacket 4, independently of the bolt hole beads 21 and the bolt/oil hole beads 22.

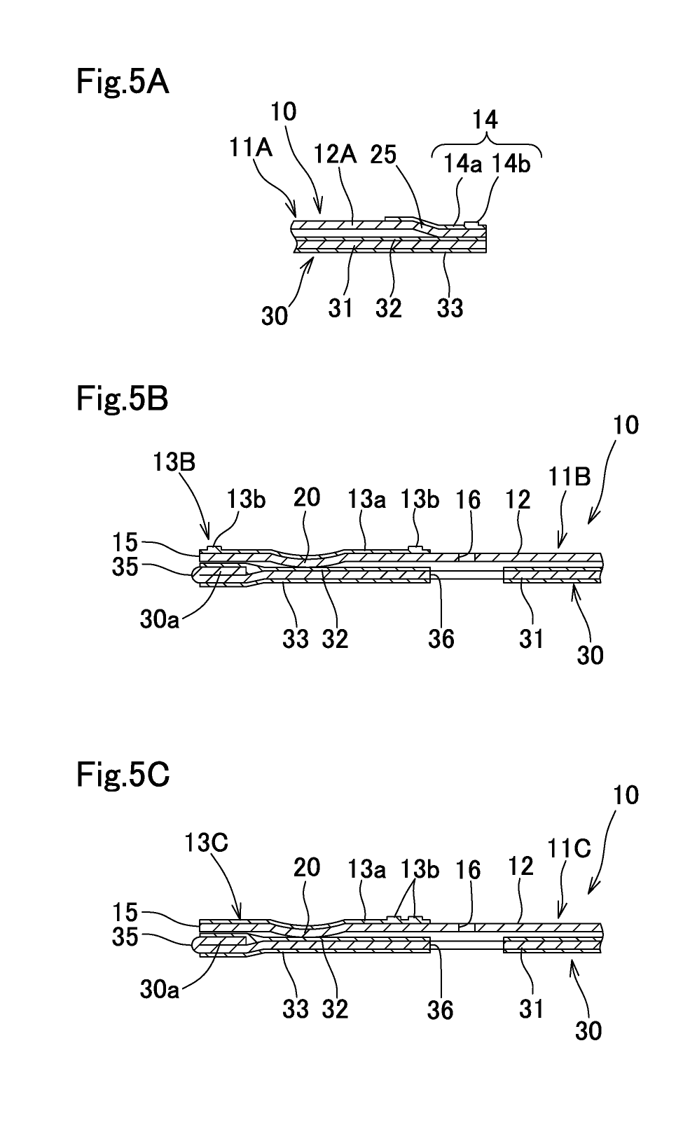

Each of the beads 20 to 23 is configured as a round bead having a partially arc-shaped cross section. Here, as in a first gasket-constituting plate 11A shown in FIG. 5A, a step bead 25 having a sloped portion formed in a first metal substrate 12A may be adopted for the beads 20 to 23, instead of the round bead. The round bead and the step bead may be combined as appropriate. For example, the combustion chamber bead 20 required to have high sealing performance may be configured as the round bead while the other beads may be configured as the step bead 25. The shapes, numbers, arrangements of the combustion chamber holes 15, the cooling water holes 16, the bolt insertion holes 17, the oil holes 18, and the respective beads 20 to 23 in the first gasket-constituting plate 11 may be optionally set in accordance with the configuration of the engine, for example.

The combustion chamber seal member 13 includes: a covering part 13a which has a width and covers the combustion chamber bead 20; and a seal projecting part 13b provided at the upper surface of the covering part 13a along an outer peripheral edge of the covering part 13a so as to project upward. The combustion chamber seal member 13 is composed of a single member that is integrally molded on the upper surface of the first metal substrate 12 by using a rubber material.

The covering part 13a of the combustion chamber seal member 13 is continuously disposed between the adjacent combustion chamber holes 15 and between the respective combustion chamber holes 15 and an inner edge of the water jacket 4 so as to cover at least the entirety of the combustion chamber bead 20, while no covering part 13a is disposed in the water jacket 4, The thickness of the covering part 13a may be set to any value, for example, 10 μm to 30 μm.

The seal projecting part 13b of the combustion chamber seal member 13 is provided outward with respect to the combustion chamber bead 20, along the outer peripheral edge of the covering part 13a, and effectively seals combustion gas that is likely to leak toward the water jacket 4 through a seal line between the combustion chamber bead 20 and the cylinder head 3. A projection height H1 of the combustion chamber bead 20 in the natural state may be set to any value, for example, 0.11 mm to 0.2 mm, A height H2 of the seal projecting part 13b from the upper surface of the first metal substrate 12 to the tip of the seal projecting part 13b may be set to 30% to 50% of the projection height H1 of the combustion chamber bead 20. A width W1 of the seal projecting part 13b may be set to 10 to 15 times the height H2 of the seal projecting part 13b. The seal projecting part 13b may be provided on both the outer peripheral side and the inner peripheral side of the combustion chamber bead 20, as in a combustion chamber seal member 13B of a first gasket-constituting plate 11B shown in FIG. 5B. Alternatively, a plurality of (two in FIG. 5C) seal projecting parts 13b may be provided in parallel, as in a combustion chamber seal member 13C of a first gasket-constituting plate 11C shown in FIG. 5C.

The outer peripheral seal member 14 includes: a covering part 14a which has a width and is provided on the upper surface of the first metal substrate 12 along the bolt hole beads 21, the bolt/oil hole beads 22, and the outer peripheral bead 23 so as to cover these beads; and a seal projecting part 14b provided on the upper surface of the covering part 14a along the outer peripheral edge of the covering part 14a so as to project upward. The outer peripheral seal member 14 is composed of a single member that is integrally molded on the upper surface of the first metal substrate 12 by using a rubber material.

The covering part 14a of the outer peripheral seal member 14 is continuously provided outward with respect to the outer edge of the water jacket 4 so as to surround the water jacket 4, while no covering part 14a is disposed in the water jacket 4. The thickness of the covering part 14a may be set to any value, for example, 20 μm to 40 μm.

The seal projecting part 14b of the outer peripheral seal member 14 is provided outward with respect to the beads 21 to 23 along the outer peripheral edge of the covering part 14a, and effectively seals fluids such as cooling water and lubricating oil, which are likely to leak outside through seal lines between the cylinder head 3 and the beads 21 to 23. A projection height H3 of the beads 21 to 23 in the natural states may be set to any value, for example, 0.11 mm to 0.2 mm. A height 114 of the seal projecting part 14b from the upper surface of the first metal substrate 12 to the tip of the seal projecting part 14b may be set to 25% to 45% of the projection height H3 of the beads 21 to 23. A width W2 of the seal projecting part 14b may be set to 10 to 15 times the height H4 of the seal projecting part 14b. Here, like the combustion chamber seal member 13B, the seal projecting part 14b may be provided not only along the outer peripheral edge of the covering part 14a but also along the inner peripheral edge of the covering part 14a, which seals cooling water, and along the inner peripheral edges of portions of the covering part 14a, which cover the bolt hole beads 21 and the bolt/oil hole beads 22. Alternatively, like the combustion chamber seal member 13C, a plurality of seal projecting parts 14b may be provided in parallel.

The combustion chamber seal member 13 and the outer peripheral seal member 14 are integrally molded on the first metal substrate 12 in a mold with using rubber pieces as described later, without spray coating or screen printing.

Examples of the rubber material forming the combustion chamber seal member 13 and the outer peripheral seal member 14 include: synthetic rubbers such as nitrile rubber (NBR), styrene-butadiene rubber (SBR), fluororubber (FKM), acrylic rubber (AR), and silicon rubber; natural rubber (NR); and a mixture thereof. The combustion chamber seal member 13 and the outer peripheral seal member 14 may be formed of the same rubber material, or different rubber materials. In particular, heat resistance is strictly required for the combustion chamber seal member 13, and therefore it may be formed of a rubber material having excellent heat resistance, such as fluororubber.

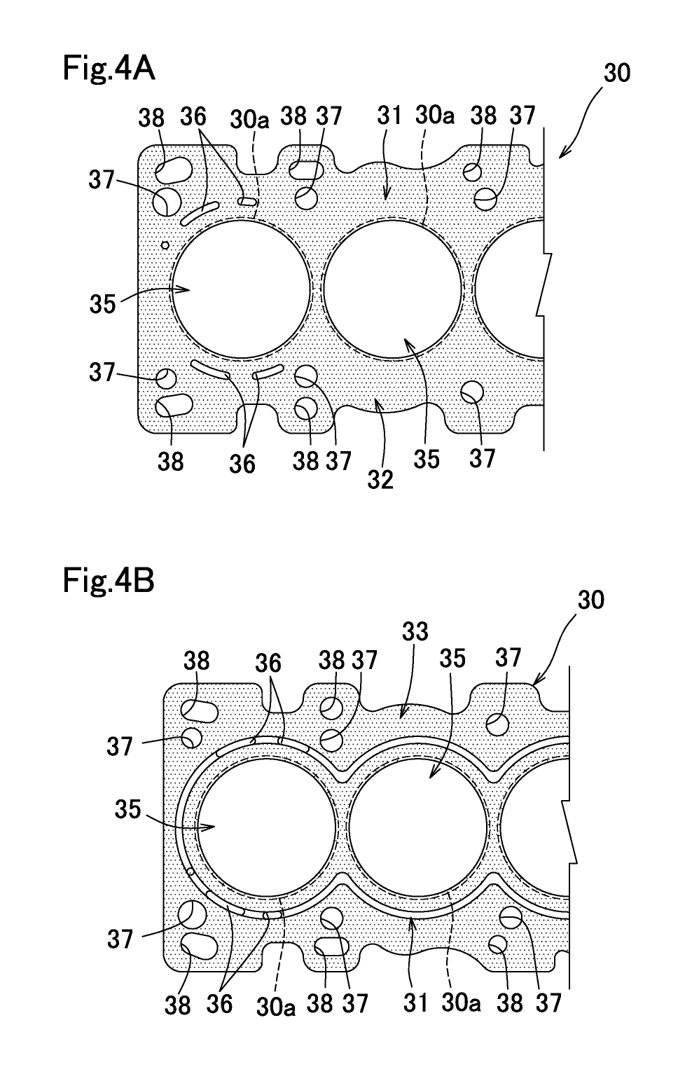

As shown in FIG. 1, FIG. 4A, and FIG. 4B, the second gasket-constituting plate 30 includes: a second metal substrate 31 formed of a metal material; and coating layers 32 and 33 which are made of a rubber material and are layered on both surfaces of the second metal substrate 31, respectively. As shown in FIG. 4A, the coating layer 32 covers the entire upper surface of the second metal plate 31. Meanwhile, as shown in FIG. 43, the coating layer 33 covers a portion, of the second metal plate 31, other than a portion corresponding to the water jacket 4 so as not to be exposed in the water jacket 4, thereby preventing peeled rubber pieces from being mixed in cooling water. In the portion corresponding to the water jacket 4, the second metal substrate 31 is exposed to the outside. In FIGS. 4A and 4B, the portions where the coating layers 32 and 33 are formed are virtually indicated by dots.

The second metal substrate 31 is formed in substantially the same plane shape as the mating surfaces 2a and 3a of the cylinder block 2 and the cylinder head 3, and is formed of a stainless steel plate such as SUS 301 based on JIS, or a known metal material having properties similar to SUS 301. The thickness of the second metal substrate 31 may be set to any value, for example, 0.03 mm to 0.15 mm, or 0.08 mm to 0.12 mm.

In the second gasket-constituting plate 30, combustion chamber holes 35, bolt insertion holes 37, and oil holes 38, which are identical in shapes and dimensions to the combustion chamber holes 15, the bolt insertion holes 17, and the oil hole 18 of the first gasket-constituting plate 11, are formed in the same positions as the holes 15, 17, and 18, respectively. Furthermore, a plurality of cooling water holes 36, each of which is larger than each of the plurality of cooling water holes 16 of the first gasket-constituting plate 11, are formed so as to correspond to the position where the water jacket 4 is formed. Here, the cooling water holes 36 of the second gasket-constituting plate 30 may have the same shapes and dimensions as the cooling water holes 16 of the first gasket-constituting plate 11.

Around the combustion chamber hole 35 of the second gasket-constituting plate 30, an annular folded-back portion 30a is superposed on a flat part 11a provided on the inner peripheral side of the combustion chamber bead 20 of the first gasket-constituting plate 11, whereby a gap equivalent to the thickness of the folded-back portion 30a is formed around the combustion chamber bead 20 with the head bolts being fastened. Thus, the combustion chamber bead 20 is prevented from being fully compressed in a flat shape.

Each of the coating layers 32 and 33 has a known structure obtained by applying a liquid rubber material onto the second metal substrate 31 by an application technique such as spray coating or screen printing, and then curing the rubber material. The thickness of the coating layer 32 may be set to 3 μm to 10 μm, and the thickness of the coating layer 33 may be set to 10 μm to 30 μm.

Examples of the rubber material forming the coating layers 32 and 33 include: synthetic rubbers such as nitrile rubber (NBR), styrene-butadiene rubber (SBR), fluororubber (FKM), acrylic rubber (AR), and silicon rubber; natural rubber (NR); and a mixture thereof.

The function of the metal gasket 10 is as follows. With the metal gasket 10 being interposed between the cylinder head 3 and the cylinder block 2, seal lines are formed along the beads 20 to 23, whereby fluids such as combustion gas, cooling water, and lubricating oil are sealed between the cylinder head 3 and the cylinder block 2. Moreover, the combustion chamber seal member 13 and the outer peripheral seal member 14 are disposed between the metal gasket 10 and the cylinder head 3, the coating layer 33 is disposed between the metal gasket 10 and the cylinder block 2, and the coating layer 32 is disposed between the first gasket-constituting plate 11 and the second gasket-constituting plate 30. Thus, the rubber layers are disposed between the respective metal members, whereby sealing performance can be significantly enhanced.

In particular, the combustion chamber seal member 13 includes the covering part 13a which covers the combustion chamber bead 20, and the seal projecting part 13b provided along the outer peripheral edge of the covering part 13a, and thus the combustion gas is mostly sealed by the combustion chamber bead 20. However, the combustion gas may leak to some extent from the combustion chamber bead 20 toward the cooling water. Even in such a case, the gap between the covering part 13a and the cylinder head 3 is extremely small, causing the gas pressure of the leaked combustion gas to be very low due to pressure loss. Therefore, even when the combustion gas is likely to leak to some extent from the combustion chamber bead 20 toward the cooling water, the combustion gas is reliably sealed by the seal projecting part 13b of the combustion chamber seal member 13. Meanwhile, like the combustion chamber seal member 13, the outer peripheral seal member 14 also includes the covering part 14a which covers the beads 21 to 23, and the seal projecting part 14b provided along the outer peripheral edge of the covering part 14a. Therefore, the cooling water and the lubricating oil can be reliably sealed by the seal projecting part 14h.

The seal members 13 and 14 are both molded in a mold by using a raw rubber material as described later, thereby increasing the manufacturing cost thereof to be higher than that of the coating layers 32 and 33. However, the seal members 13 and 14 are formed only on the necessary portions along the beads 20 to 23, thereby minimizing the amount of used rubber material. In addition, productivity can be enhanced as compared with the case of removing the unnecessary rubber layer with a water jet. Thus, an increase in manufacturing cost of the metal gasket 10 can be inhibited as a whole.

Moreover, both the seal members 13 and 14 are provided only on the cylinder head 3 side, thereby enhancing sealing performance with inhibiting increase in manufacturing cost of the metal gasket 10. That is, the cylinder head 3 and the cylinder block 2 are formed of casting, and have greater surface roughness than the metal gasket 10. Therefore, sealing performance at the contact portion of the metal gasket 10 with the cylinder head 3 or the cylinder block 2 easily deteriorates. In particular, the cylinder head 3 is more likely to be deformed than the cylinder block 2 when the head bolts are fastened, thereby causing sealing performance thereof to easily deteriorate. Therefore, by forming the seal members 13 and 14 only on the cylinder head 3 side in the metal gasket 10, sealing performance can be enhanced while minimizing an increase in manufacturing cost of the metal gasket 10.

Furthermore, both the seal members 13 and 14 are formed as a single member that is integrally molded with a rubber material. Therefore, as compared with the case where seal members are formed through an application technique such as spray coating or screen printing, the following effects can be achieved: bonding strength to the first metal substrate 12 can be increased through pressure bonding; even when narrow seal projecting parts 13b and 14h are formed, peeling of the seal projecting parts 13b and 14b can be effectively avoided; and the seal members 13 and 14 having the seal projecting parts 13b and 14b can be molded without increasing the number of manufacturing steps.

Moreover, the seal members 13 and 14 and the coating layer 33 are not disposed in the water jacket 4, thereby avoiding peeling off of the seal members 13 and 14 and the coating layer 33 due to contact with cooling water. Accordingly, reduction in cooling performance due to clogging of peeled rubber pieces can be prevented.

Next, other embodiments, in which the layered structure of the gasket-constituting plate of the aforementioned metal gasket 10 is partially altered, will be described. The same components as those of the aforementioned embodiment are denoted by the same reference numerals, and the detailed description thereof will be omitted.

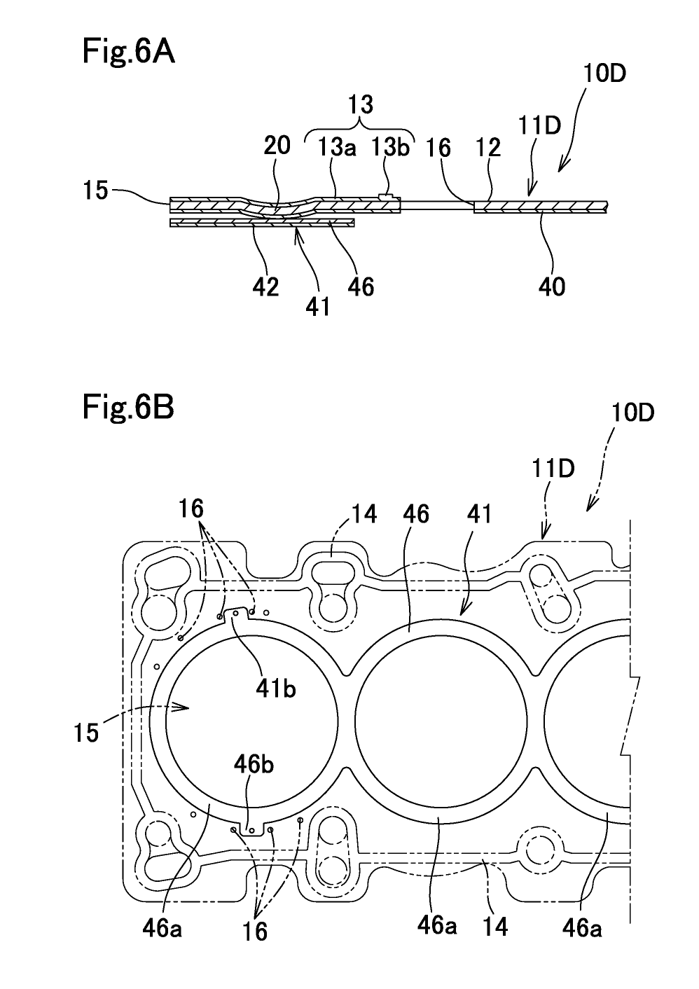

(1) A metal gasket 10D shown in FIG. 6A includes a first gasket-constituting plate 11D instead of the first gasket-constituting plate 11, and a shim plate 41 instead of the second gasket-constituting plate 30. The first gasket-constituting plate 11D is obtained by forming a coating layer 40 on the lower surface of the first gasket-constituting plate 11. The shim plate 4 is disposed in a layered state at the lower side of the first gasket-constituting plate 11D.

The coating layer 40 of the first gasket-constituting plate 11D is formed on the lower surface of the first metal substrate 12 so as not to be disposed in a position corresponding to the water jacket 4. Like the coating layer 33, the coating layer 40 is formed through spray coating or screen printing of a liquid rubber material, and curing of the rubber material.

As shown in FIGS. 6A and 6B, the shim plate 41 includes a metal substrate 46, and a coating layer 42 formed on the lower surface of the metal substrate 46. The metal substrate 46 includes: a plurality of ring parts 46a connected in series so as to surround the combustion chamber holes 15; and joint parts 46b projecting into the water jacket 4. The shim plate 41 is, in the joint part 46b, joined to the first gasket-constituting plate 11D through spot welding, riveting, mechanical clinching, or the like, to be disposed in a layered state at the lower side of the first gasket-constituting plate 11D.

The thickness of the shim plate 41 may be set to any value, for example, 0.01 mm to 0.15 mm, or 0.05 mm to 0.10 mm. With the head bolts being fastened, the thickness of the metal gasket 10D at the combustion chamber bead 20 is increased by the thickness of the shim plate 41, for reducing the vertical motion of the combustion chamber bead 20.

The metal substrate 46 is formed of a stainless steel plate such as SUS 301 based on JIS, or a known metal material having properties similar to those of SUS 301.

Like the coating layers 32 and 33, the coating layer 42 is formed through spray coating of a liquid rubber material, and curing of the rubber material. The coating layer 42 ensures sufficient sealing performance at the contact surface between the cylinder block 2 and the shim plate 41.

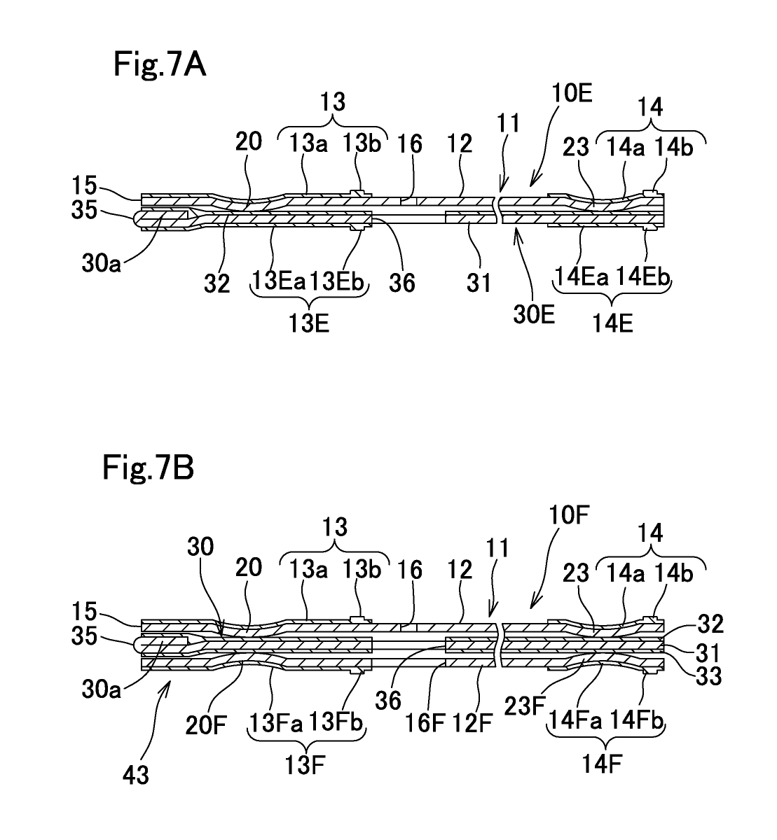

(2) A metal gasket 10E shown in FIG. 7A includes, instead of the second gasket-constituting plate 30, a second gasket-constituting plate 30E disposed in a layered state at the lower side of the first gasket-constituting plate 11 of the metal gasket 10.

The second gasket-constituting plate 30E includes, instead of the coating layer 33 on the lower surface of the second gasket-constituting plate 30, a combustion chamber seal member 13E and an outer peripheral seal member 14E provided so as to correspond to the combustion chamber seal member 13 and the outer peripheral seal member 14, respectively.

The combustion chamber seal member 13E includes: a covering part 13Ea which has a width and is provided along the combustion chamber bead 20 so as to cover the combustion chamber bead 20; and a seal projecting part 13Eb which is provided on the lower surface of the covering part 13Ea along the outer peripheral edge of the covering part 13Ea so as to project downward. Like the combustion chamber seal member 13, the combustion chamber seal member 13E is composed of a single member that is integrally molded at the lower surface of the second metal substrate 31 by using a rubber material.

The outer peripheral seal member 14E includes: a covering part 14Ea which has a width and is provided along the beads 21 to 23 so as to cover the beads 21 to 23; and a seal projecting part 14Eb which is provided on the lower surface of the covering part 14Ea along the outer peripheral edge of the covering part 14Ea so as to project downward. Like the outer peripheral seal member 14, the outer peripheral seal member 14E is composed of a single member that is integrally molded at the lower surface of the second metal substrate 31 by using a rubber material.

In the metal gasket 10E, the combustion chamber seal member 13 and the outer peripheral seal member 14 having the seal projecting parts 13b and 14b, respectively, are disposed at a contact portion with the cylinder head 3, and the combustion chamber seal member 13E and the outer peripheral seal member 14E having the seal projecting parts 13Eb and 14Eb, respectively, are disposed at the contact portion with the cylinder block 2, whereby sealing performance is further enhanced.

(3) A metal gasket 10F shown in FIG. 7B further includes a third gasket-constituting plate 43 provided at the lower side of the second gasket-constituting plate 30 of the metal gasket 10, so that the first gasket-constituting plate 11, the second gasket-constituting plate 30, and the third gasket-constituting plate 43 are integrated in a layered state.

The third gasket-constituting plate 43 is substantially mirror-symmetrical with respect to the first gasket-constituting plate 11, and includes beads 20F to 23F (beads 21F and 22F are not shown) corresponding to the beads 20 to 23 of the first gasket-constituting plate 11, and includes seal members 13F and 14F, on the lower surface of a first metal substrate 12F, which correspond to the seal members 13 and 14. However, a cooling water hole 16F is formed in the same way as the cooling water hole 36 of the second gasket-constituting plate 30. In the metal gasket 10F′, the lower surface of the second gasket-constituting plate 30 is not exposed in the water jacket 4, allowing the coating layer 33 to be disposed over the entire lower surface of the second metal substrate 31.

The combustion chamber seal member 13F includes: a covering part 13Fa which has a width and is provided along the combustion chamber bead 20 so as to cover the combustion chamber bead 20; and a seal projecting part 13Fb provided on the lower surface of the covering part 13Fa along the outer peripheral edge of the covering part 13Fa so as to project downward. Like the combustion chamber seal member 13, the combustion chamber seal member 13F is composed of a single member that is integrally molded at the lower surface of the first metal substrate 12F by using a rubber material.

The outer peripheral seal member 14F includes: a covering part 14Fa which has a width and is disposed along the beads 21F to 23F so as to cover the beads 21F to 23F; and a seal projecting part 14Fb disposed at the lower surface of the covering part 14Fa along the outer peripheral edge of the covering part 14Fa so as to project downward. Like the outer peripheral seal member 14, the outer peripheral seal member 14F is composed of a single member that is integrally molded at the lower surface of the first metal substrate 12F by using a rubber material.

(4) A metal gasket 10G shown in FIG. 7C does not include the second gasket-constituting plate 30 of the metal gasket 10F, and includes, instead of the third gasket-constituting plate 43, a third gasket-constituting plate 43G which is obtained by forming a coating layer 44 on the upper surface of the third gasket-constituting plate 43, and is disposed in a layered state at the lower side of the first gasket-constituting plate 11. Like the coating layer 32, the coating layer 44 is formed through spray coating or screen printing of a liquid rubber material over the entire upper surface of the first metal substrate 12F, and curing of the rubber material.

(5) A metal gasket 10H shown in FIG. 7D includes a first gasket-constituting plate instead of the first gasket-constituting plate 11 of the metal gasket 10G, and the metal substrate 46 of the aforementioned shim plate 41 between the first gasket-constituting plate 11D and the third gasket-constituting plate 43G. The first gasket constituting plate 11D of the metal gasket 10D has a coating layer 40 on its lower surface.

(6) A metal gasket 10I shown in FIG. 7E includes, instead of the folded-back portion 30a of the metal gasket 10, a folded-back portion 301a extending to the outside of the seal line of the combustion chamber bead 20. The metal gaskets 10E and 10F may each include the folded-back portion 30Ia instead of the folded-back portion 30a.

In the metal gaskets 10F, 10G, and 10H, the combustion chamber seal member 13 and the outer peripheral seal member 14 having the seal projecting parts 13b and 14b, respectively, are disposed at the contact portion with the cylinder head 3, and the combustion chamber seal member 13F and the outer peripheral seal member 14F having the seal projecting parts 13Fb and 14Fb, respectively, are also disposed at the contact portion with the cylinder block 2, whereby sealing performance is further enhanced.

As for the beads provided in the metal gaskets 10E to 10H, the step bead may be adopted, or the round bead and the step bead may be optionally combined, as described above.

Next, metal gaskets of other embodiments, each being composed of a single gasket-constituting plate, will be described. The same components as those of the aforementioned embodiment are denoted by the same reference numerals, and the detailed description thereof will be omitted.

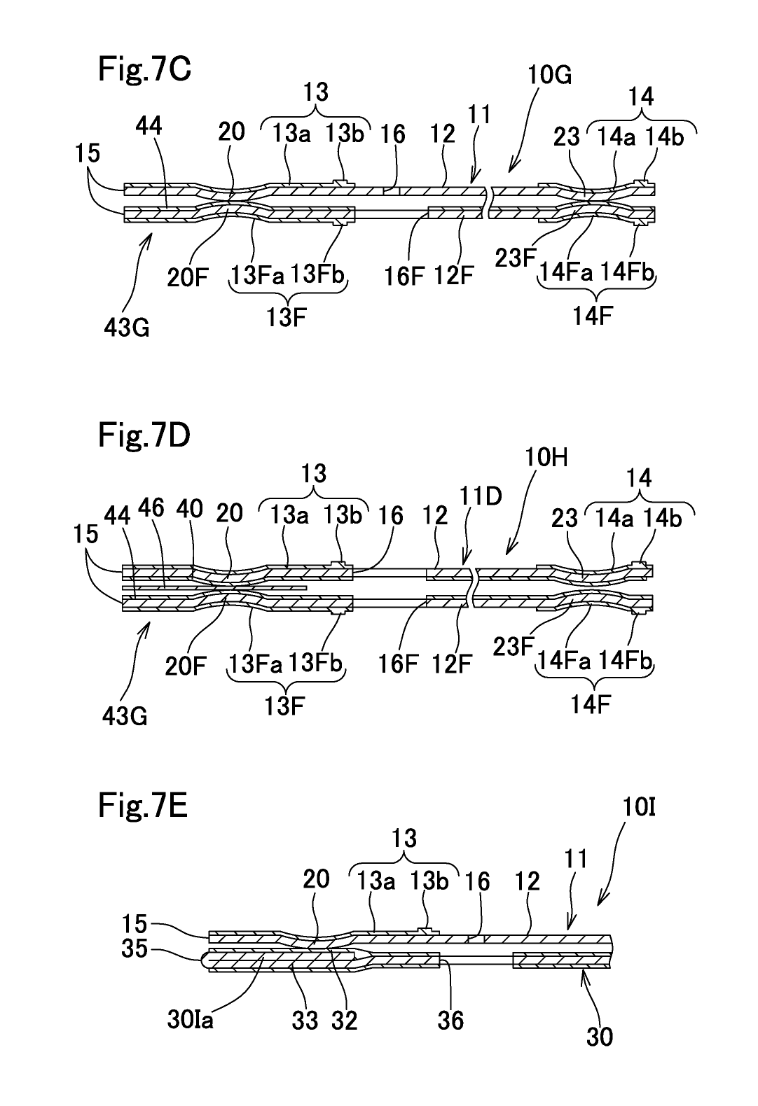

(1) A metal gasket 10J shown in FIG. 8A is composed of a single gasket-constituting plate 11J which is obtained by partially altering the structure of the first gasket-constituting plate 11 of the metal gasket 10.

The gasket-constituting plate 11J includes a metal substrate 12J, and a coating layer 50 formed on the lower surface of the metal substrate 12J.

The metal substrate 12J includes: an outer peripheral bead 23J instead of the outer peripheral bead 23 that is a round bead in the first metal substrate 12 of the first gasket-constituting plate 11; and cooling water holes 16J instead of the cooling water holes 16 of the first gasket-constituting plate 11. The outer peripheral bead 23J is a step bead. The cooling water holes 16J has the same structure as the cooling water holes 36 of the second gasket-constituting plate 30, The other components are the same as those of the first metal substrate 12, Here, the outer peripheral bead 23J may be a round bead.

Like the coating layer 33, the coating layer 50 is formed on the lower surface of the metal substrate 12J so as not to be disposed in the position corresponding to the water jacket 4. The coating layer 50 is formed through spray coating or screen printing of a liquid rubber material, and curing of the rubber material.

In the metal gasket 10J, the combustion chamber seal member 13 and the outer peripheral seal member 14 enhance sealing performance between the metal gasket 10J and the cylinder head 3 which is more likely to be deformed than the cylinder block 2.

(2) A metal gasket 10K shown in FIG. 8B is composed of a single gasket-constituting plate 11K, The single gasket-constituting plate 11K includes, instead of the coating layer 50 at the lower surface of the gasket-constituting plate 11J, a combustion chamber seal member 13K and an outer peripheral seal member 14K disposed at the lower surface of the metal substrate 12J so as to correspond to the combustion chamber seal member 13 and the outer peripheral seal member 14 of the gasket-constituting plate 11J, respectively.

The combustion chamber seal member 13K includes: a covering part 13Ka which has a width and is disposed along the combustion chamber bead 20 so as to cover the combustion chamber bead 20; and a seal projecting part 13Kb which is disposed on the lower surface of the covering part 13Ka along the outer peripheral edge of the covering part 13Ka so as to project downward. Like the combustion chamber seal member 13, the combustion chamber seal member 13K is composed of a single member that is integrally molded at the lower surface of the metal substrate 12J by using a rubber material.

The outer peripheral seal member 14K includes: a covering part 14Ka which has a width and is disposed along the bead 23J so as to cover the bead 23J; and a seal projecting part 14Kb which is disposed on the lower surface of the covering part 14Ka along the outer peripheral edge of the covering part 14Ka so as to project downward. Like the outer peripheral seal member 14, the outer peripheral seal member 14K is composed of a single member that is integrally molded at the lower surface of the metal substrate 12J by using a rubber material.

The metal gasket 10K includes the combustion chamber seal member 13 and the outer peripheral seal member 14 disposed on the upper surface thereof, and the combustion chamber seal member 13K and the outer peripheral seal member 14K disposed on the lower surface thereof. Accordingly, sealing performance with respect to the cylinder head 3 and the cylinder block 2 can be enhanced although the manufacturing cost is increased as compared with the metal gasket 10J.

(3) In a metal gasket 10L shown in FIG. 8C, a gasket-constituting plate 11L includes, instead of the metal substrate 12J of the gasket-constituting plate 11J, a metal substrate 12L in which a stopper part 51 having a plurality of waveform parts 51a smaller in height than the combustion chamber bead 20 are disposed at the inner peripheral side of the combustion chamber bead 20. The other components are the same as those of the gasket-constituting plate 11J. In the metal gasket 10L, the same function and effect as those of the metal gasket 10J are achieved, and the stopper part 51 prevents the combustion chamber bead 20 from being fully compressed.

(4) In a metal gasket 10M shown in FIG. 8D, a gasket-constituting plate 11M includes, instead of the metal substrate 12J of the gasket-constituting plate 11J, a metal substrate 12M in Which an annular recess 52 smaller in height than the combustion chamber bead 20 is formed at the inner peripheral side of the combustion chamber bead 20. The recess 52 is filled with a hard resin having heat resistance, such as fluororesin, to provide a filled part 53, and a covering part 13a is formed so as to cover the filled part 53, whereby a stopper part 54 is formed by the recess 52 and the filled part 53. In this metal gasket 10M, the same function and effect as those in the metal gasket 10J are achieved, and the stopper part 54 prevents the combustion chamber bead 20 from being fully compressed.

As for the beads provided in the metal gaskets 10J to 10M, either the step bead or the round bead may be adopted, or the round bead and the step bead may be optionally, combined, as described above.

The present invention is also applicable to any metal gasket having a known structure other than the structures described above, by providing a seal member, which is composed of a single member having a covering part and a seal projection and integrally molded by using a rubber material, along a bead, on an outer surface of a metal substrate which forms at least one of both surfaces of the metal gasket.

Next, a method for manufacturing a gasket-constituting plate having a combustion chamber seal member and an outer peripheral seal member will be described. Although a method for manufacturing the first gasket-constituting plate 11 will be described as an example, the manufacturing method of the present invention is also applicable to any gasket-constituting plate other than the first gasket-constituting plate 11, as long as the gasket-constituting plate has a combustion chamber seal member and an outer peripheral seal member.

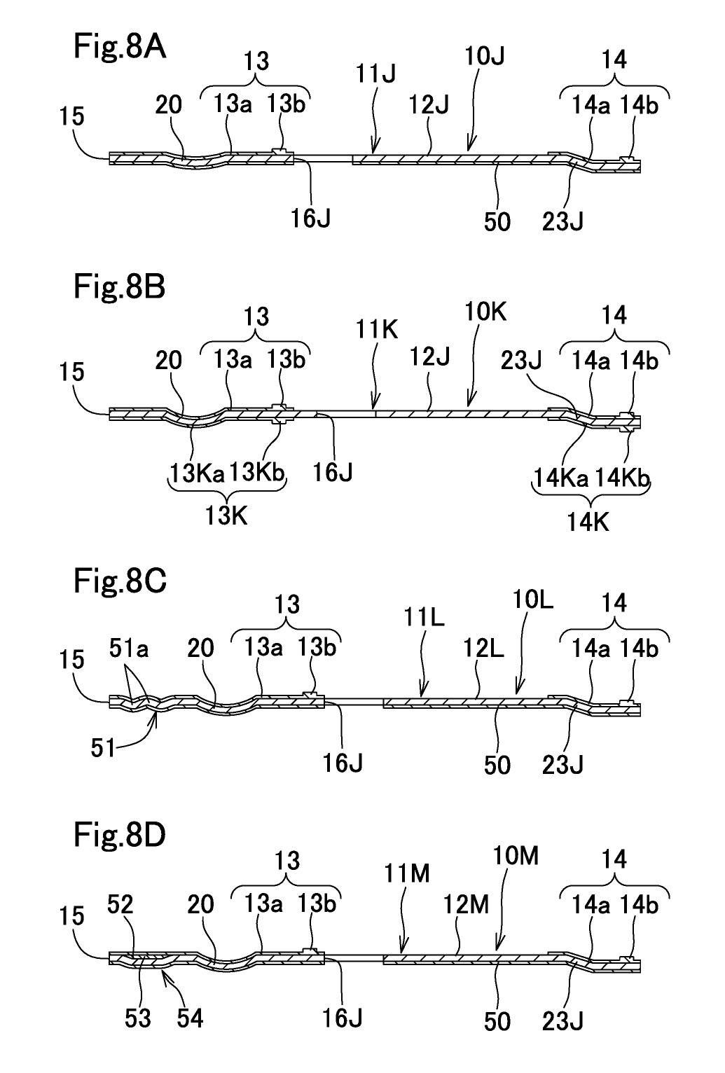

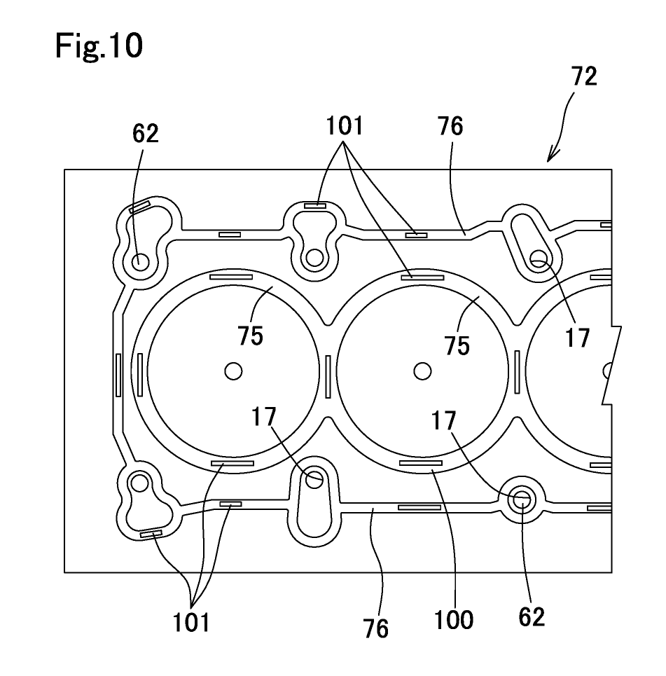

First, a sealing mold 60 for molding the combustion chamber seal member 13 and the outer peripheral seal member 14 will be described. As shown in FIG. 9 and FIG. 11A, the sealing mold 60 includes: a lower mold 61 having a flat surface on which a blank metal plate 100 is positioned and placed; and an upper mold 70 composed of a male mold 71 and a female mold 72.

The blank metal plate 100 is obtained as follows. That is, a flat metal sheet such as a stainless steel sheet, which will be the first metal substrate 12 of the first gasket-constituting plate 11, is subjected to punching to form a metal plate having a plane shape substantially along the outer shape of the mating surfaces 2a and 3a of the cylinder block 2 and the cylinder head 3, and then necessary holes such as the combustion chamber holes 15, the cooling water holes 16, the bolt insertion holes 17, and the oil holes 18 are formed in the metal plate. However, this punching may be performed after molding of the combustion chamber seal member 13 and the outer peripheral seal member 14.

In the lower mold 61, positioning pins 62 projecting upward are provided so as to correspond to the bolt insertion holes 17. The blank metal plate 100 is positioned and placed on the lower mold 61 with the positioning pins 62 being inserted into the bolt insertion holes 17.

The male mold 71 includes a first male mold 73 having a plane shape corresponding to the combustion chamber seal member 13 and a second male mold 74 having a plane shape corresponding to the outer peripheral seal member 14. At an end surface of the first male mold 73, an annular groove 73a, whose shape and dimension conform to the seal projecting part 13b of the seal member 13, is formed so as to correspond to the seal projecting part 13b. At an end surface of the second male mold 74, an annular groove 74a whose shape and dimension conform to the seal projecting part 14b of the seal member 14, is formed so as to correspond to the seal projecting part 14b. In the female mold 72, a first fitting groove 75 in which the first male mold 73 is to be fined, and a second fining groove 76 in which the second male mold 74 is to be fitted, are formed. In the case where a plurality of seal projecting parts 13b should be molded for one seal member 13 or a plurality of seal projecting parts 14b should be molded for one seal member 14, grooves 73a or grooves 74a as many as the seal projecting parts 13b or the seal projecting parts 14b need to be provided. Instead of the upper mold 70, an upper mold having a lower surface at which grooves whose dimensions conform to the combustion chamber seal member 13 and the outer peripheral seal member 14 are formed in positions corresponding to the seal members 13 and 14, may be adopted.

A method for molding the combustion chamber seal member 13 and the outer peripheral seal member 14 will be described.

First, as shown in FIG. 9, after the blank metal plate 100 is degreased, the positioning pins 62 are inserted into the bolt insertion holes 17 to position and place the blank metal plate 100 on the lower mold 61.

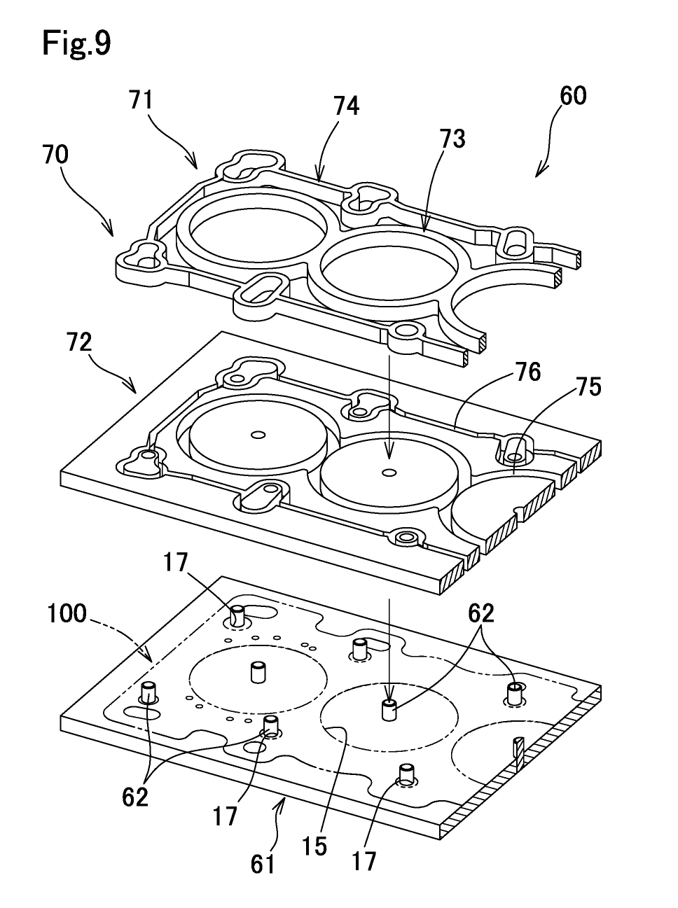

Next, as shown in FIG. 10 and FIG. 11A, the female mold 72 is placed on the blank metal plate 100, and a plurality of uncured material rubber pieces 101 are placed spaced apart from each other at positions corresponding to the combustion chamber seal member 13 of the blank metal plate 100, through the first fitting groove 75. In addition, a plurality of uncured material rubber pieces 101 are placed spaced apart from each other at positions corresponding to the outer peripheral seal member 14 of the blank metal plate 100, through the second fining groove 76. The material rubber pieces 101 are placed at predetermined positions by a predetermined amount so that the combustion chamber seal member 13 and the outer peripheral seal member 14 are formed without excess and deficiency. However, before placement of the rubber pieces, an adhesive agent may be applied in a layered state at positions where the seal members 13 and 14 are to be formed on the upper surface of the blank metal plate 100, to enhance adhesive strength between the blank metal plate 100 and the seal members 13 and 14.

Examples of the material rubber pieces 101 include: synthetic rubbers such as nitrile rubber (NBR), styrene-butadiene rubber (SBR), fluororubber (FKM), acrylic rubber (AR), and silicon rubber; natural rubber (NR); and a mixture thereof. As for the material rubber pieces 101, the cross-sectional shape and the dimensions thereof may be optionally set as long as the seal members 13 and 14 can be molded without excess and deficiency. Instead of the material rubber pieces 101, uncured rubber strings may be put in the fitting grooves 75 and 76, or uncured rubber powder may be uniformly dispersed in the fitting grooves 75 and 76.

Next, as shown in FIG. 11B, the material rubber pieces 101 are softened through heating at 50° C., for example, and the first male mold 73 and the second male mold 74 of the male mold 71 are fitted in the first fitting groove 75 and the second fitting groove 76 of the female mold 72. Then, the material rubber pieces 101 are heated and compressed at the end portions of the male molds 73 and 74, whereby the material rubber pieces 101 are spread in the fitting grooves 75 and 76. At this time, the grooves 73a and 74a are also filled with the spread rubber. Then, the material rubber pieces 101, being spread as described above, are heated and retained for a predetermined time to cure the rubber material, thereby molding, on the blank metal plate 100, the combustion chamber seal member 13 having the covering part 13a and the seal projecting part 13b of desired thicknesses, and the outer peripheral seal member 14 having the covering part 14a and the seal projecting part 14b of desired thicknesses.

Next, the lower mold 61 and the upper mold 70 are opened, and a blank metal plate 100A on which the combustion chamber seal member 13 and the outer peripheral seal member 14 are integrally molded is taken out. Then, burrs at the outer edges of the combustion chamber seal member 13 and the outer peripheral seal member 14 are frozen and removed by using liquid nitrogen, for example.

Next, the combustion chamber bead 20, the bolt hole beads 21, the bolt/oil hole beads 22, and the outer peripheral bead 23 are formed on the blank metal plate 100A by a known method.

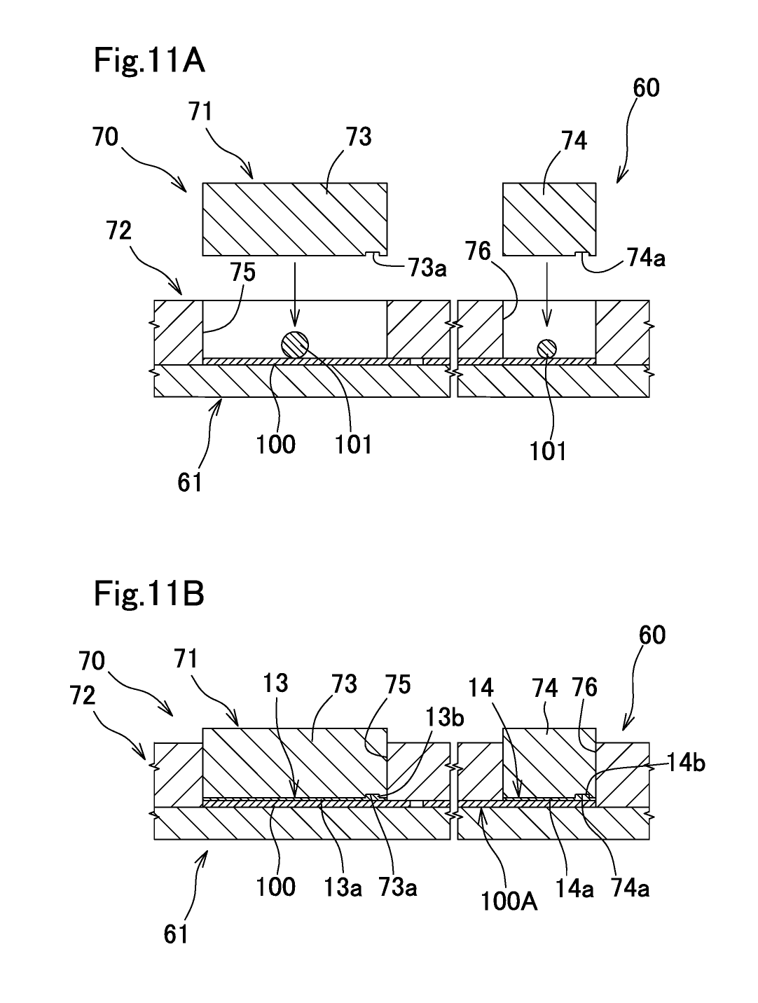

For example, as shown in FIG. 12, a convex die 80 and a concave die 81 are used. The convex die 80 has: a projection 80a projecting downward, which is provided so as to correspond to the combustion chamber bead 20; and a projection 80b projecting downward, which is provided so as to correspond to the beads 21 to 23 (in FIG. 12, the beads 22 and 23 are not shown). The concave die 81 has: a recess 81a formed so as to correspond to the combustion chamber bead 20; and a recess 81b formed so as to correspond to the beads 21 to 23 (in FIG. 12, the beads 22 and 23 are not shown). With the blank metal plate 100A being placed on the concave die 81, the convex die 80 is moved downward, and the blank metal plate 100A is stamped by the projections 80a and 80h of the convex die 80 to form the beads 20 to 23.

In the method for manufacturing the first gasket-constituting plate 11, the material rubber pieces 101 are heated and compressed to be cured and spread between the blank metal plate 100 and the upper mold 70 placed on the lower mold 61, whereby the combustion chamber seal member 13 is integrally molded on the blank metal plate 100 along the combustion chamber bead 20 while the outer peripheral seal member 14 is integrally molded on the blank metal plate 100 along the beads 21 to 23. Therefore, the manufacturing cost of the first gasket-constituting plate 11 can be reduced by minimizing wasteful use of the rubber material. In addition, bonding strength of the seal members 13 and 14 to the blank metal plate 100 can be increased through pressure bonding, as compared with the case where the seal members are formed through screen printing or spray coating of a liquid rubber material onto the blank metal plate 100, and curing of the rubber material.

In manufacturing the first gasket-constituting plate 11D, the coating layer 40 is formed on the lower surface side of the blank metal plate 1004 prepared as described above, through spray coating or screen printing of a liquid rubber material and curing of the rubber material, so that the coating layer 40 is not disposed in the position corresponding to the water jacket 4. Thereafter, the beads 20 to 23 are formed in the same manner as described above.

In manufacturing the second gasket-constituting plate 30E, the seal members 13E and 14E are molded on the blank metal plate of the second metal substrate 31 in the same manner as that for the blank metal plate 100A, and the folded-back portion 30a is formed. Then, the coating layer 32 is formed through spray coating or screen printing of a liquid rubber material on the upper surface of the blank metal plate, and curing of the rubber material.

In manufacturing the first gasket-constituting plate 43, the seal members 13F and 14F are molded on the lower surface of the blank metal plate of the first metal substrate 12F in the same manner as that for the blank metal plate 100A, and thereafter, the beads 20F to 23F are formed.

In manufacturing the first gasket-constituting plate 43G, the seal members 13F and 14F are molded on the lower surface of the blank metal plate of the first metal substrate 12F in the same manner as that for the blank metal plate 100A. Then, the coating layer 44 is formed on the upper surface of the blank metal plate through spray coating or screen printing of a liquid rubber material, and curing of the rubber material. Thereafter, the beads 20F to 23F are formed.

In manufacturing the gasket-constituting plate 11J, the beads 20 and 23J are formed by a known method on the blank metal plate 100A prepared as described above. In manufacturing the gasket-constituting plates 11L, 11M, the beads 20 and 23J are formed and the stopper parts 51, 54 are respectively molded on the blank metal plate 100A by known methods. Thereafter, or prior thereto, the coating layer 50 is formed on the lower surface side of the blank metal plate 100A through spray coating or screen printing of a liquid rubber material, and curing of the rubber material such that the coating layer 50 is not disposed in the position corresponding to the water jacket 4.

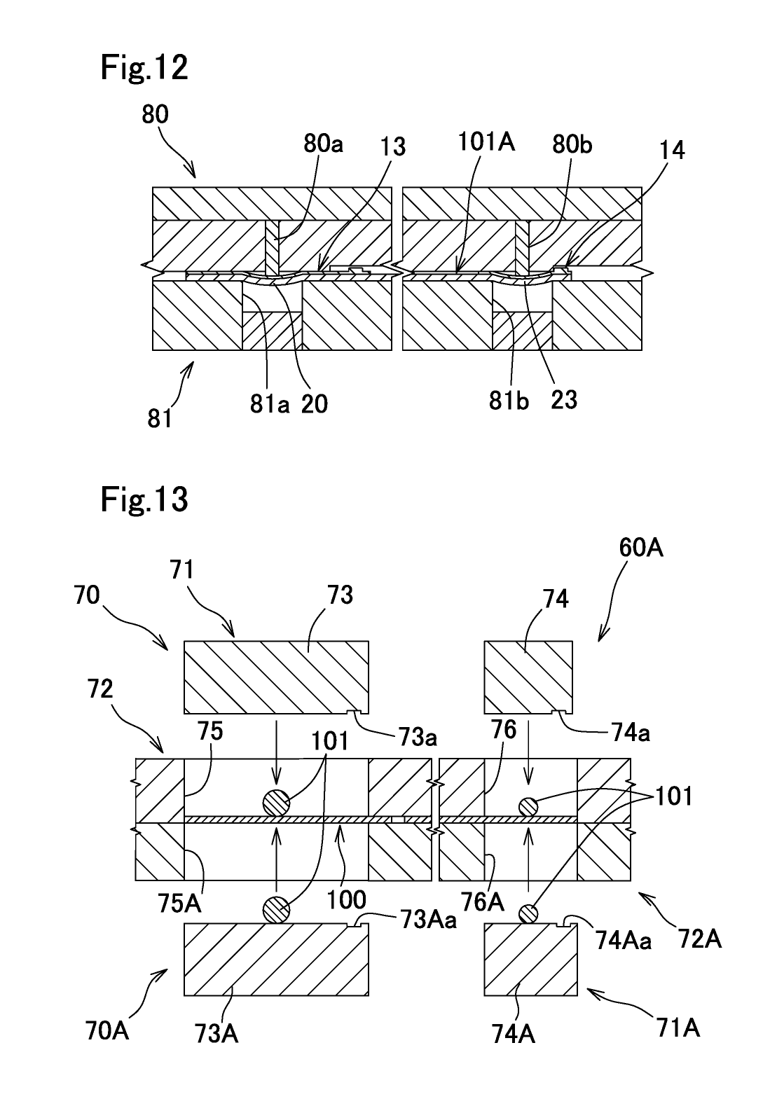

In the case where the combustion chamber seal members 13 and 13K and the outer peripheral seal members 14 and 14K are molded on both surfaces of the metal substrate 12J as in the gasket-constituting plate 11K, a sealing mold 60A shown in FIG. 13, which includes a lower mold 70A having a male mold 71A and a female mold 72A vertically symmetrical with the male mold 71 and the female mold 72, is used instead of the lower mold 61.

Using the sealing mold 60A, the combustion chamber seal members 13 and 13K and the outer peripheral seal members 14 and 14K are simultaneously molded on both surfaces of the blank metal plate 100, as follows. That is, first, a plurality of material rubber pieces 101 are placed spaced apart from each other on the upper surfaces of the first male mold 73A and the second male mold 74A of the lower-side male mold 71A, and the blank metal plate 100 is positioned and placed on the lower-side female mold 72A. Then, the upper-side female mold 72 is placed on the blank metal plate 100, and a plurality of material rubber pieces 101 are placed spaced apart from each other on the blank metal plate 100 through the first fitting groove 75 and the second fitting groove 76. Next, the first male molds 73 and 73A are fitted into the first fitting grooves 75 and 75A of the female molds 72 and 72A, respectively, and the second male molds 74 and 74A are fitted into the second fitting grooves 76 and 76A of the female molds 72 and 72A, respectively. Then, the material rubber pieces 101 are heated and compressed to be cured and spread on the upper and lower surfaces of the blank metal plate 100 between the first male molds 73 and 73A, while the material rubber pieces 101 are heated and compressed to be cured and spread on the upper and lower surfaces of the blank metal plate 100 between the second male molds 74 and 74A, whereby the grooves 73a and 73Aa and the grooves 74a and 74Aa are also filled with the rubber material. The blank metal plate 100 in this state is retained for a predetermined time, whereby the combustion chamber seal members 13 and 13K and the outer peripheral seal members 14 and 14K are simultaneously formed on both surfaces of the blank metal plate 100.

In the aforementioned manufacturing method, the seal members having the covering parts and the seal projecting parts are integrally molded by using the material rubber pieces. However, seal members having no seal projecting parts, i.e., having only covering parts, may be molded by omitting the grooves 73a, 74a, 73Aa, and 74Aa.

The metal gasket and the method for manufacturing the gasket-constituting plate according to the present invention are applicable not only to the head gasket interposed between the cylinder block 2 and the cylinder head 3 of the vehicle engine 1 and the manufacturing method of such a head gasket, but also to a gasket disposed between a cylinder head and an exhaust manifold, and a method for manufacturing a gasket-constituting plate of such a gasket, and to a gasket interposed between two members in an engine other than vehicle engines or two members in industrial machinery, and a method for manufacturing a gasket-constituting plate of such a gasket.

While the invention has been described in detail, the foregoing description is in all aspects illustrative and not restrictive. It will be understood that numerous other modifications and variations can be devised without departing from the scope of the invention.

1. A metal gasket comprising:
a single gasket-constituting plate on which a bead for sealing is provided;
a covering part having a substantially uniform thickness of 10 μm to 40 μm, the covering part being provided on at least one surface of the gasket-constituting plate, along the bead so as to cover the bead;
a seal projecting part provided on an outer surface of the covering part, which is outside the bead, along the covering part, the seal projecting part projecting outward in a thickness direction of the covering part; and
a seal member including the covering part and the seal projecting part, the seal member being composed of a single member that is integrally molded on the gasket-constituting plate through heat-compression molding of material rubber pieces, wherein
a projection height of the seal projecting part from the gasket-constituting plate to a tip of the seal projecting part is set to 25% to 50% of a projection height of the bead.

2. A metal gasket comprising:
a plurality of gasket-constituting plates layered on each other, at least one of the gasket-constituting plates being provided with a bead for sealing;
a covering part having a substantially uniform thickness of 10 μm to 40 μm, the covering part being provided on an outer surface of one of the gasket-constituting plates, which is disposed on at least one of outer sides of the metal gasket, along the bead so as to cover the bead in a plan view;
a seal projecting part provided on an outer surface of the covering part, which is outside the bead, along the covering part; the seal projecting part projecting outward in a thickness direction of the covering part;
a seal member including the covering part and the seal projecting part, the seal member being composed of a single member that is integrally molded on the gasket-constituting plate having the covering part, through heat-compression molding of material rubber pieces, wherein
a projection height of the seal projecting part from the gasket-constituting plate having the covering part to a tip of the seal projecting part is set to 25% to 50% of a projection height of the bead.

3. The metal gasket according to claim 2, wherein the gasket-constituting plate having the bead is disposed on the at least one of the outer sides of the metal gasket, and the covering part is provided on the outer surface of the gasket-constituting plate having the bead, along the bead so as to cover the bead.

4. The metal gasket according to claim 1, further comprising, in addition to the seal projecting part, a seal projecting part that projects outward in the thickness direction of the covering part, and is provided on an outer surface of the covering part, which is inside the bead.

5. The metal gasket according to claim 2, further comprising, in addition to the seal projecting part, a seal projecting part that projects outward in the thickness direction of the covering part, and is provided on an outer surface of the covering part, which is inside the bead.

6. The metal gasket according to claim 1, wherein fluororubber is used as a rubber material forming the seal member.

7. The metal gasket according to claim 2, wherein fluororubber is used as a rubber material forming the seal member.

8-11. (canceled)
